(19) United States
(12) Patent Application Publication
(10) Pub. No.: US 2009/0135593 A1
(43) Pub. Date: May 28, 2009

(54) ASSEMBLY OF LIGHTING PANEL MODULES AND MANUFACTURING METHOD THEREOF

(75) Inventor: CHIH MING LAI, PINGTUNG COUNTY (TW)

Correspondence Address: WPAT, PC;INTELLECTUAL PROPERTY ATTORNEYS, 2030 MAIN STREET, SUITE 1300, IRVINE, CA, 92614, US

(73) Assignee: FOXSEMICON INTEGRATED TECHNOLOGY INC., MIAOLI COUNTY (TW)

(21) Appl. No.: 12/257,586

(22) Filed: Oct. 24, 2008

(30) Foreign Application Priority Data
Nov. 23, 2007 (TW) 096144459

(51) Int. Cl. F21V 19/00

(52) U.S. Cl. 362/234

(57) ABSTRACT

An assembly of lighting panel modules comprises a plurality of lighting panel modules and adhesive compound between the plurality of lighting panel modules. Each of the lighting panel modules comprises a light guide plate and at least one light emitting component. The light emitted from the light emitting component enters the light guide plate and exits from the surface of the light guide plate. The adhesive compound combines the light guide plates of the lighting panel modules. The adhesive compound can transmit the light within the light guide plates.

### BACKGROUND OF THE INVENTION

(A) Field of the Invention

The present invention relates to an assembly of lighting panel modules and manufacturing method thereof, and more particularly, to an assembly of lighting panel modules and manufacturing method thereof for improving the display quality.

(B) Description of the Related Art

Commercial lighting panel module assemblies and advertising lighting boxes are displayed outdoors or in public buildings in order to attract the attention of passersby. Lighting panel module assemblies and advertising lighting boxes utilize colored transparency for advertisement placed in front of a light emitting device. The light from the light emitting device passes through the colored advertisement transparency, and the graphics or text on the colored advertisement transparency are accordingly highlighted. Therefore, passersby are attracted to the contents of the colored advertisement transparency.

FIG. 1 is an illustration of a conventional assembly of lighting panel modules. An assembly 10 is comprised of a plurality of lighting panel modules 11. The area of the assembly 10 is approximately equal to the sum of the areas of the plurality of smaller lighting panel modules 11. However, there are gaps 12 between adjacent lighting panel modules 11 due to limitations of the current assembly technology. The air existing in the gap 12 and the light guide plate of the lighting panel module 11 result in the refraction and reflection of light at their junction, and thereby a loss of light energy occurs. Additionally, the gap 12 will not be able to guide the majority of light to the front, and will result in dark bands on the display surface. These dark bands are seen as areas of discontinuity in the graphics or text in the display, negatively affecting the viewing interests or visual senses of the viewer.

When light guide components (e.g. light guide plate or diffuser) are connected to each other and combined as an assembly, discontinuity or gaps at their junctions commonly result in significant blockage of light so that light cannot be transmitted between them. In order to transmit light from one light guide component to an adjacent one, a conventional method is to lap the junction surfaces and reduce the width of the air gap. For example, when the width of the air gap is less than 0.2 mm, the issue of light discontinuity can be resolved. However, this lapping process will undoubtedly increase the manufacturing cost and complexity of the whole process, and the light discontinuity issue still is not completely eliminated.

### SUMMARY OF THE INVENTION

One aspect of the present invention provides an assembly of lighting panel modules and manufacturing method thereof, wherein the plurality of lighting panel modules are connected with each other by filling adhesive compound therebetween, thereby smoothly and evenly transmitting light from one module to another. Consequently, the existence of dark bands is eliminated from the display of the assembly.

Another aspect of the present invention provides a low cost assembly of lighting panel modules. The plurality of lighting panel modules are connected with each other by filling adhesive compound therebetween. Therefore, no special processing method (e.g. lapping and grinding processes) is required to completely eliminate the issue of light transmission interruption.

According to the aforesaid aspects, the present invention discloses an assembly of lighting panel modules comprising a plurality of lighting panel modules and adhesive compound between the plurality of lighting panel modules. Each of the lighting panel modules comprises a light guide plate and at least one light emitting component. The light emitted by the light emitting component enters the light guide plate and exits from a surface of the light guide plate. The adhesive compound connects the light guide plate of each lighting panel module, and can transfer or transmit the light from one of the light guide plates to an adjacent light guide plate.

The present invention discloses a method for assembling lighting panel modules comprising the steps of providing at least two lighting panel modules; applying adhesive compound to at least one edge of a light guide plate of one of the lighting panel modules, wherein the profile of the adhesive compound reaches a high at the center of the edge and becomes gradually lower towards two sides of the edge; enabling one edge of the light guide plate of another lighting panel module to contact a single point of the adhesive compound; and moving the edge of the latter light guide plate to gradually come into contact with the complete length of the adhesive compound along the edge.

### BRIEF DESCRIPTION OF THE DRAWINGS

The objectives and advantages of the present invention will become apparent upon reading the following description and upon reference to the accompanying drawings in which:

FIG. 1 is an illustration of a conventional assembly of lighting panel modules;

FIG. 2 is an illustration showing an assembly of lighting panel modules in accordance with the present invention;

FIG. 3 is a cross-sectional view showing the assembly of lighting panel modules along a line 1-1 in FIG. 1 in accordance with the present invention;

FIGS. 4A-4B are illustrations showing the assembling steps of lighting panel modules in accordance with the present invention;

FIG. 5 is an illustration showing another assembling step of lighting panel modules in accordance with the present invention;

FIGS. 6A-6B are illustrations showing further assembling steps of lighting panel modules in accordance with the present invention; and

FIG. 7 is an illustration showing another assembly of lighting panel modules in accordance with the present invention.

### DETAILED DESCRIPTION OF THE INVENTION

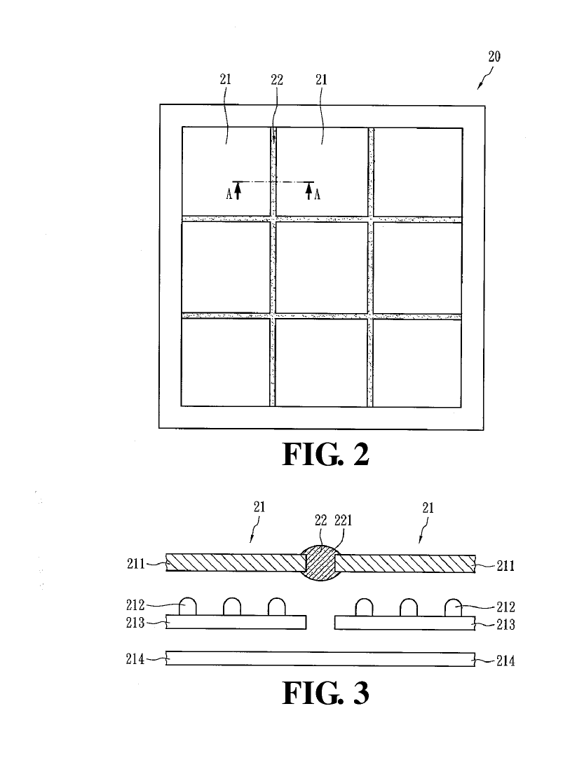

FIG. 2 is an illustration showing an assembly of lighting panel modules in accordance with the present invention. An assembly 20 is comprised of a plurality of lighting panel modules 21. The plurality of lighting panel modules 21 with a smaller area can be assembled together to form the assembly 20 with a larger area. Regardless how close two adjacent lighting panel modules 21 are to each other, a gap still exists between them. In this regard, the present invention fills adhesive compound 22 between two adjacent lighting panel modules 21. Therefore, the light can be smoothly and evenly transmitted between them so as to eliminate dark bands from the display of the whole assembly.

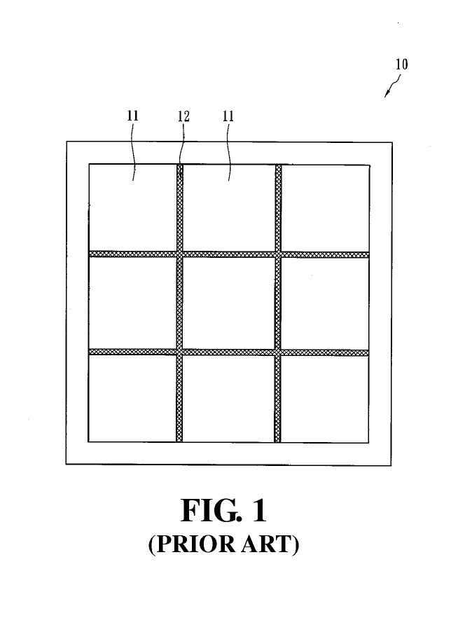

FIG. 3 is a cross-sectional view showing the assembly of lighting panel modules along a line 1-1 in FIG. 1 in accordance with the present invention. Each of the lighting panel modules 21 comprises a light guide plate 211 and at least one light emitting component 213. Two light guide plates 211 of the two adjacent lighting panel modules 21 are connected with each other by the adhesive compound 22. The adhesive compound 22 can transmit the light from one of the light guide plates 211 to another, connected one. The refractive index of the adhesive compound 22 preferably balances that of the light guide plate 211. That is, the light is smoothly and evenly transmitted from the light guide plate 211 to the adhesive compound 22 to prevent the majority of light from being reflected from the side surface of the light guide plate 211 towards itself. The material of the light guide plate 211 can be polycarbonate, PMMA, and acrylic glass, and their refractive indexes are 1.584-1.586, 1.489, and 1.490-1.492, respectively. For the purpose of balancing the refractive index of the above-mentioned material of the light guide plate 211, the adhesive compound 22 of polymer or their combination preferably have the following characteristics: (1) good elasticity under room temperature; (2) good stickiness; (3) superior gap-filling capability. For example, such polymer can be glue, isinglass, resin, synthetic rubber, neoprene rubber, polybutadiene rubber, polysulfide rubber, hot melt adhesive, pressure-sensitive adhesive, natural rubber, polyisobutylene, butyl rubber, polyacrylate-based pressure-sensitive adhesive, polysulfide rubber, silicone rubber, fluoro rubber, PUA compounds, etc.

The light emitting component 212 can be a light emitting diode. In general, the light emitting component 212 is mounted onto a circuit board 213. Preferably, a reflector 214 is disposed under the lighting panel module 21, and therefore the light emitted from the light emitting component 212 is directed completely toward the light guide plate 211, thereby improving the light utilization.

To improve the scattering capability of the adhesive compound 22, particles 221 such as SiO₂ dots can be added to the adhesive compound 22. Therefore, light can be redirected toward each possible direction so as to improve the brightness of the junction where the adhesive compound 22 is filled.

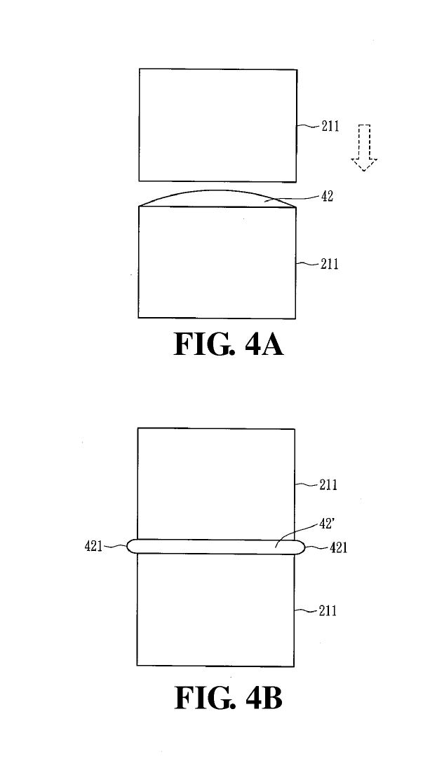

FIGS. 4A-4B are illustrations showing the assembling steps of lighting panel modules in accordance with the present invention. Two lighting panel modules 21 are provided, where the adhesive compound 42 is applied to one edge of the light guide plate 211 of a lighting panel module 21, wherein the distribution of the adhesive compound 42 is thicker at the center and gradually reduced towards the sides. Subsequently, a middle point at one edge of the light guide plate 211 of another lighting panel 21 contacts the adhesive compound 42 first, and then the former light guide plate 211 is gradually moved to the later light guide plate 211 along the downwards direction indicated by the arrow in the figure so that other points of the edge of the later light guide plate 211 sequentially contact the adhesive compound 42. It is preferable to reduce the distance between the two adjacent light guide plates 211.

As shown in FIG. 4B, the adhesive compound 40′ completely fills the space between the two light guide plates 211. According to the aforesaid combination method, air bubbles can be prevented from being trapped into the adhesive compound 42′. Preferably, the overflow portions 421′ at both ends of the adhesive compound 42′ can be removed for a superior appearance.

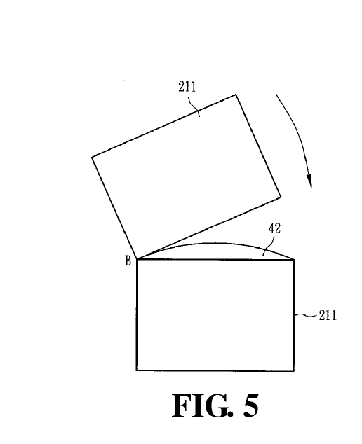

FIG. 5 is an illustration showing other assembling steps of lighting panel modules in accordance with the present invention. One corner B of the light guide plate 211 of the upper lighting panel module 21 contacts the end of the adhesive compound 42. The upper light guide plate 211 is rotated clockwise and along the direction indicated by the arrow in this figure so that other points along the same edge sequentially contact the adhesive compound 42. Air bubbles can thereby be prevented from being trapped in the adhesive compound 42 during the combination process.

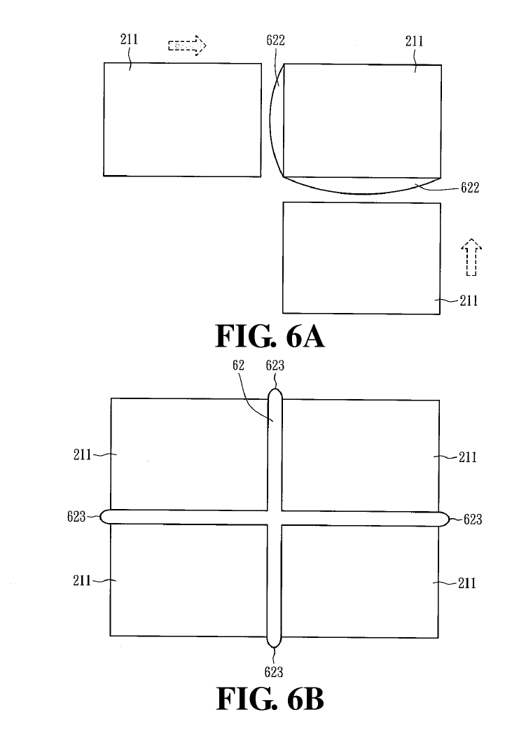

FIGS. 6A-6B are illustrations showing further assembling steps of lighting panel modules in accordance with the present invention. The two adjacent edges of a light guide plate 211 are coated with adhesive compound 622, and then two light guide plates 211 are connected to the adhesive compound 622 on the two edges respectively. Therefore, the light guide plates 211 of the three lighting panel modules 21 can be assembled together. By similar processes, the light guide plate 211 of another lighting panel module 21 can be connected to the aforesaid light guide plates 211 of the three lighting panel modules 21. The adhesive compound 62 between the four light guide plates 211 can successfully transmit and project light. It is preferred that the overflow portions 623 of the adhesive compound 62 on the four sides be removed.

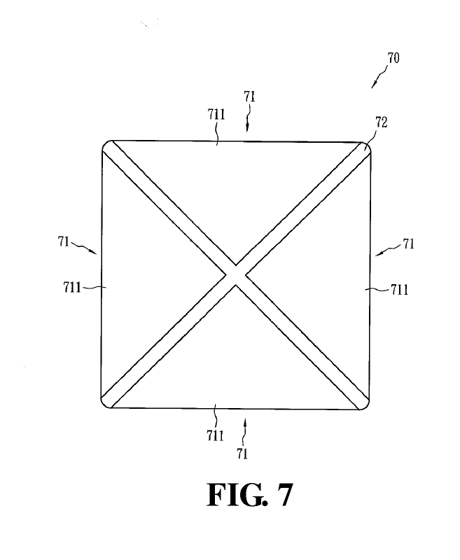

FIG. 7 is an illustration showing another assembly of lighting panel modules in accordance with the present invention. An assembly 70 comprises a plurality of triangular lighting panel modules 71. The adhesive compound 72 is filled between the light guide plates 711 of the lighting panel modules 71. The lighting panel modules 71 can be presented as a triangular shape or other polygonal shapes, e.g. hexagonal, pentangle, trapezoid, rhombus shaped etc.

The above-described embodiments of the present invention are intended to be illustrative only. Those skilled in the art may devise numerous alternative embodiments without departing from the scope of the following claims.

What is claimed is:

1. An assembly of lighting panel modules, comprising:
a plurality of lighting panel modules, each of which comprises a light guide plate and at least one light emitting component, wherein light emitted by the light emitting component enters the light guide plate; and
adhesive compound disposed between the adjacent light guide plates and combining the light guide plates together for transmitting the light within the light guide plates.

2. The assembly of lighting panel modules of claim 1, wherein the refractive index of the adhesive compound balances the refractive index of the light guide plate.

3. The assembly of lighting panel modules of claim 1, wherein the adhesive compound is a polymer with elasticity, stickiness, and gap filling capacity at room temperature.

4. The assembly of lighting panel modules of claim 1, wherein the material of the adhesive compound is glue, isinglass, resin, synthetic rubber, neoprene rubber, polybutadiene robber, polysulfide rubber, hot melt adhesive, pressure-sensitive adhesive, natural rubber, polyisobutylene, butyl rubber, polyacrylate-based pressure-sensitive adhesive, polysulfide rubber, silicone rubber, fluoro rubber, or PUA compounds.

5. The assembly of lighting panel modules of claim 1, wherein the adhesive compound is further enhanced with addition of a plurality of particles to improve a scattering effect on the light.

6. The assembly of lighting panel modules of claim 1, wherein the material of the light guide plate is polycarbonate, PMMA, or acrylic glass.

7. The assembly of lighting panel modules of claim 1, wherein the light emitted by the light emitting component enters the light guide plate, and exits from a surface of the light guide plate.

8. The assembly of lighting panel modules of claim 1, wherein the light emitting component is a light-emitting diode.

9. The assembly of lighting panel modules of claim 8, wherein the light emitting component of each of the lighting panel modules is mounted on a circuit board.

10. The assembly of lighting panel modules of claim 8, wherein each of the lighting panel modules further comprises a reflector, wherein the reflector can reflect the light emitted from the light emitting component toward the light guide plate.

11. The assembly of lighting panel modules of claim 8, wherein each of the lighting panel modules is polygonal.

12. A method for assembling lighting panel modules, comprising the steps of:
providing at least two lighting panel modules;
applying an adhesive compound to at least one edge of a first light guide plate in one of the lighting panel modules, wherein the adhesive compound can transmit light from the light guide plate;
causing one point on one edge of a second light guide plate of the other lighting panel module contact the adhesive compound first; and
causing other points along the edge of the light guide plate to sequentially contact the adhesive compound.

13. The method for assembling lighting panel modules of claim 12, wherein the profile of the adhesive compound reaches a high at the center of the applied edge and becomes gradually lower towards two sides of the applied edge.

14. The method for assembling lighting panel modules of claim 12, wherein the adhesive compound is applied to two adjacent edges of the first light guide plate.

15. The method for assembling lighting panel modules of claim 14, wherein the profile of the adhesive compound reaches a high at the center of one of the applied edges and becomes gradually lower towards two sides of the one of the applied edges.

16. The method for assembling lighting panel modules of claim 15, wherein the center point of the edge of the second light guide plate contacts the adhesive compound first.

17. The method for assembling lighting panel modules of claim 15, wherein the corner of the edge of the second light guide plate contacts the adhesive compound first, and then the second light guide plate is rotated to make the entire edge contact the adhesive compound.

18. The method for assembling lighting panel modules of claim 11, further comprising the step of removing portions of the adhesive compound overflowing at two sides of the edge of the first flight guide plate.

19. The method for assembling lighting panel modules of claim 11, wherein the adhesive compound is applied to the two adjacent edges of the first light guide plate.

20. The method for assembling lighting panel modules of claim 11, wherein the refractive index of the adhesive compound balances the refractive index of the first light guide plate or the second light guide plate.
